(19) United States
(12) Patent Application Publication
(10) Pub. No.: US 2015/0315494 A1
(43) Pub. Date: Nov. 5, 2015

(54) METHODS AND SYSTEMS FOR IMPROVING THE PROPERTIES OF PRODUCTS OF A HEAVY FEED STEAM CRACKER

(71) Applicants: Patrick Loring Hanks, Bridgewater, NJ (US); Larry Lee Iaccino, Seabrook, TX (US)

(72) Inventors: Patrick Loring Hanks, Bridgewater, NJ (US); Larry Lee Iaccino, Seabrook, TX (US)

(73) Assignee: ExxonMobil Research and Engineering Company, Annandale, NJ (US)

(21) Appl. No.: 14/691,849

(22) Filed: Apr. 21, 2015

Related U.S. Application Data
(60) Provisional application No. 61/986,986, filed on May 1, 2014.

(51) Int. Cl. C10G 69/02; C01B 3/02; C10G 51/02; C10G 55/02; B01J 19/00; B01J 19/24

(52) U.S. Cl. CPC C10G 69/02; B01J 19/008; B01J 19/245; C10G 51/02; C10G 55/02; C01B 3/02; B01J 2219/24

(57) ABSTRACT

Methods and systems are provided for improving viscosity of a heavy hydrocarbon product stream such as a vapor-liquid separator drum bottoms stream, a steam cracker tar stream, or a combination thereof by subjecting the stream to cavitation to reduce the viscosity of the product stream.

### CROSS-REFERENCE TO RELATED APPLICATION

The present application claims priority to U.S. Patent Application Ser. No. 61/986,986, filed May 1, 2014.

### FIELD

The present invention relates to a method and system for improving the properties of products of heavy feed steam crackers. More specifically, the present invention relates to methods and systems of improving the properties of bottoms products of heavy feed stream crackers, including steam cracker tar, utilizing hydrodynamic cavitation for viscosity reduction.

### BACKGROUND

Heavy feed steam crackers combine crude oil, or a heavy cut thereof (such as atmospheric distillation tower bottoms), with steam to facilitate the separation of lighter hydrocarbon molecules from the heavier hydrocarbon molecules in the heavy feed. The mixed feed is then fed to a vapor-liquid separator drum, sometimes referred to as a K-Pot, where heavier product, K-Pot bottoms, are separated from the volatile hydrocarbons and steam. Some heavy feed crackers obtain heavy liquid feeds that have been previously processed in non-integrated facilities to improve feed properties such as hydrogen or sulfur content.

The volatile hydrocarbons and steam are then fed through heating coils in a furnace and then are fed to a heavy feed cracker. A portion of the volatile hydrocarbon molecules are cracked into even lighter hydrocarbon molecules, such as C₂ and C₃ range molecules, depending on the feed, the steam to feed ratio, and the operating conditions of the heavy feed steam cracker. Heavier hydrocarbons are recovered from the heavy feed steam cracker as steam cracker tar.

U.S. Pat. No. 6,979,757 discloses a method for utilizing whole crude oil as a feedstock for the pyrolysis furnace of an olefin production plant wherein the feedstock after preheating is subjected to mild thermal cracking assisted with controlled cavitation conditions until substantially vaporized, the vapors being subjected to severe cracking in the radiant section of the furnace.

Due to high viscosity, the K-Pot bottoms and steam cracker tar products must be blended with flux before being used as fuel oil or sold into dispositions such as carbon black feedstock. Typically flux is worth more than the final dispositions so an alternative means of viscosity reduction would be beneficial.

### SUMMARY

The present invention addresses these and other problems by methods and systems for treating heavy hydrocarbon streams associated with a heavy feed steam cracker unit.

In one aspect, a method is provided for treating a heavy hydrocarbon containing stream. The method includes subjecting a bottoms product stream from a steam cracker to hydrodynamic cavitation with a cavitation device to convert at least a portion of the hydrocarbons present in the bottoms product stream to lower molecular weight hydrocarbons and thereby yield a converted product stream having a viscosity less than the bottoms product stream.

In another aspect, a system is provided for improving viscosity of a heavy hydrocarbon product stream. The system includes a vapor-liquid separator configured to receive a mixed feed of a heavy hydrocarbon feed having a T50 greater than or equal to 400° F. and a T95 greater than or equal to 650° F. and steam and configured to separate the mixed feed into (a) a steam cracker feed stream comprising steam and volatile hydrocarbons in the mixed feed and (b) a bottoms stream. The system also includes a steam cracker downstream of the vapor-liquid separator drum and configured to receive the steam cracker feed stream, wherein the steam cracker is adapted to crack the steam cracker feed to yield a plurality of cracked hydrocarbon streams. The plurality of cracked hydrocarbon streams may be separated in a unit such as a fractionator, of which the fractionator bottoms stream is often referred to as tar. The system also includes a cavitation device configured to receive the bottoms tar stream and reduce the viscosity of the bottoms tar stream.

In yet another aspect, a method is provided for treating a heavy steam cracker vapor-liquid separator drum bottoms stream. The method includes subjecting a bottoms stream from a heavy steam cracker vapor-liquid separator drum to cavitation in a cavitation device to convert at least a portion of the hydrocarbons present in the bottoms stream to lower molecular weight hydrocarbons and thereby yield a converted product stream having a viscosity less than the bottoms stream.

In yet another aspect, a system is provided for treating a heavy hydrocarbon product stream. The system includes a mixed feed stream comprising a heavy hydrocarbon feed having a T50 greater than or equal to 400° F. and a T95 greater than or equal to 650° F. and steam; a steam cracker that is adapted to crack the mixed feed to yield a plurality of cracked hydrocarbon products; a separator that separates the plurality of cracked hydrocarbon products into at least two fractions including a bottoms product fraction; and a cavitation device configured to receive a bottoms product fraction from the separation vessel.

In yet another aspect, a system is provided for improving viscosity of a heavy hydrocarbon product stream. The system includes a vapor-liquid separator drum configured to receive a mixed feed of a heavy hydrocarbon feed having a T50 greater than or equal to 400° F. and a T95 greater than or equal to 650° F. and steam and configured to separate the mixed feed into (a) a steam cracker feed stream comprising steam and volatile hydrocarbons in the mixed feed and (b) a bottoms stream. The system also includes a steam cracker downstream of the vapor-liquid separator drum and configured to receive the steam cracker feed stream, wherein the steam cracker is adapted to crack the steam cracker feed stream to yield a cracked hydrocarbon stream and a steam cracker tar stream. The system also includes a hydrodynamic cavitation unit configured to receive a product stream selected from the group consisting of the bottoms stream, the steam cracker tar stream, or a combination thereof, wherein the hydrodynamic cavitation unit is adapted to hydrodynamically cavitate the product stream and thereby reduce the viscosity of the product stream.

### BRIEF DESCRIPTION OF THE DRAWINGS

FIG. 1 is a cross section view of an exemplary hydrodynamic cavitation unit, which may be employed in one or more embodiments of the present invention.

FIG. 2 is a flow diagram of a stream cracker with integrated vapor-liquid separator which may be employed in one or more embodiments of the present invention.

FIG. 3 is a flow diagram of a system for improving the viscosity of a heavy hydrocarbon product stream associated with a heavy feed steam cracker unit.

FIG. 4 is a chart, illustrating simulated distillation curves for a neat steam cracker tar and a cavitated steam cracker tar.

### DETAILED DESCRIPTION

Methods and systems are provided for improving viscosity of heavy feed steam cracker bottoms and tar products. Advantageously, systems and methods disclosed herein may be employed to reduce the viscosity of K-pot bottoms and steam cracker tar to improve their value and/or to better facilitate their disposition into fuel oil or other dispositions. These and other advantages may be realized by incorporating a hydrodynamic cavitation unit to the heavy feed steam cracker to crack and thereby reduce the viscosity of tar and/or other bottoms products, such as pre-steam cracker vapor-liquid separator vessels (e.g., K-pot bottoms) rejected from the steam cracker.

The methods and systems disclosed herein may be utilized with heavy feed steam crackers receiving crude oil feeds or heavy cuts thereof, including vacuum gas oils or processed cuts. For example, the methods and systems disclosed herein may be used with heavy hydrocarbon feed streams having a T50 boiling point (the temperature at which 50 wt % of the material boils off at atmospheric pressure) of greater than or equal to 400° F. and/or a T95 boiling point (the temperature at which 95 wt % of the material boils off at atmospheric pressure) of greater than or equal to 650° F. In general, the methods and systems disclosed herein may be utilized with vapor-liquid separator drum bottoms, steam cracker tar, and the like in which viscosity reduction is desired. The methods may also be particularly useful with steam cracker tar streams having a T5 boiling point (the temperature at which 5 wt % of the material boils off at atmospheric pressure) greater than 300° F. and/or a T95 boiling point greater than 1100° F. and/or less than 1400° F.

In any embodiment, the methods disclosed herein may be used for improving viscosity of a heavy hydrocarbon product stream. The method may include mixing a heavy crude oil feed, such as a heavy crude oil or a cut thereof, with steam to produce a mixed stream; separating the heavy hydrocarbon product stream from the mixed stream; and subjecting the heavy hydrocarbon product stream to hydrodynamic cavitation to crack at least a portion of the hydrocarbons in the heavy hydrocarbon product stream and thereby reduce the viscosity of the heavy hydrocarbon product stream to produce a reduced viscosity product stream. The methods may be employed in conjunction with a heavy feed stream cracker. For example, the heavy hydrocarbon product stream may be a stream cracker tar stream that is separated from the mixed stream after the mixed stream is fed to a heavy feed steam cracker.

In another embodiment, the heavy hydrocarbon product stream may be a bottoms product of a vapor-liquid separator vessel (e.g., a K-pot bottom stream) that is separated from the mixed stream upstream of a heavy feed steam cracker. In such an embodiment, the lighter hydrocarbon stream, mixed with steam, from the vapor-liquid separator vessel may be fed to the steam cracker.

Similarly, systems are disclosed herein for improving viscosity of a heavy hydrocarbon product stream. The system may include a vapor-liquid separator drum that receives a mixed feed of heavy crude oil and steam and separates the mixed feed into a steam cracker feed stream comprising steam and lighter hydrocarbons in the mixed feed and a bottoms stream. The system may also include a steam cracker downstream of the vapor-liquid separator drum that receives the steam cracker feed stream. The steam cracker may be adapted to crack the steam cracker feed to yield a cracked hydrocarbon stream and a stream cracker tar stream. The system further includes a hydrodynamic cavitation unit that receives a product stream selected from the group consisting of the bottoms stream from the vapor-liquid separator drum, the steam cracker tar stream, or a combination thereof. For example, the bottoms stream and the steam cracker tar stream may be blended, or the hydrodynamic cavitation unit may process the streams separately. The hydrodynamic cavitation unit is adapted to hydrodynamically cavitate the product stream to reduce the viscosity of the product stream as will be described in greater detail subsequently.

The product of the hydrodynamic cavitation unit, i.e., the reduced viscosity product stream, may ultimately be blended with other products to produce a fuel oil. For example, the product may be used in a No. 6 Fuel Oil. In any embodiment, the product may be used alone or in combination with a cutter stock in a fuel oil product having a viscosity of less than or equal to 380 cSt at 50° C., a specific gravity of between about 0.96 and about 1.01, and a sulfur level of 3.5 wt % or less or 1.5 wt % or less. Viscosity can be measured by ASTM D445, density or specific gravity by ASTM D4052, and sulfur by ASTM D2622. In other embodiments, the product may be used alone or in combination with a cutter stock in a No. 5 Fuel Oil.

In any embodiment, reduced viscosity product stream may be fed to a fractionating unit to fractionate the reduced viscosity product in a light stream and a heavy stream. In any embodiment, the light stream may be mixed with the steam cracker feed stream, e.g., downstream of the vapor-liquid separator vessel and upstream of the steam cracker, and fed to the stream cracker for cracking.

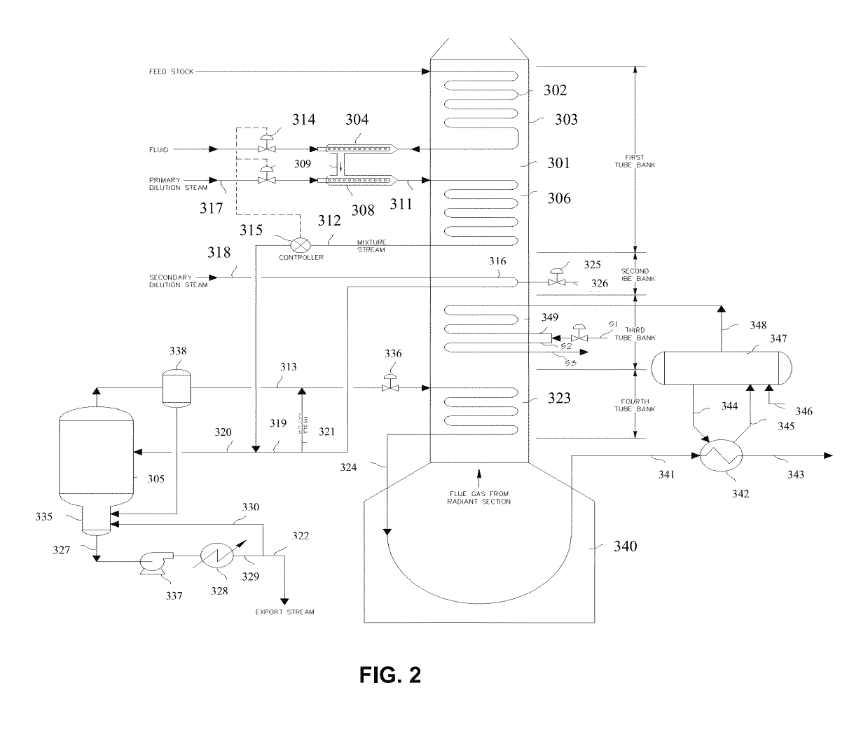

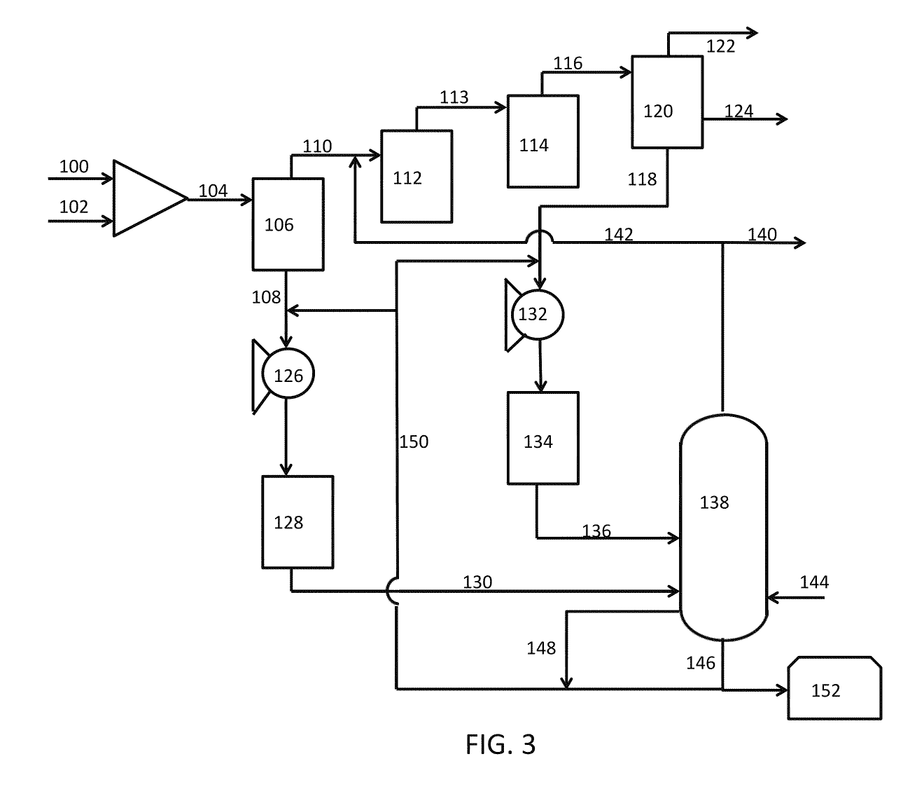

An exemplary embodiment is illustrated in FIG. 3. As illustrated, a heavy crude feed 100, which may be any of the heavy crude feeds disclosed herein, is mixed with steam 102, and the mixed feed 104 is fed to a vapor-liquid separator vessel 106 (e.g., such as after passing through one or more convective heating tube banks within a heavy feed stream cracker) wherein a lighter (i.e., more volatile) hydrocarbon stream 110, comprising lighter hydrocarbons from heavy crude feed 100 and steam, is separated from bottoms 108. The vapor-liquid separator vessel 106 may be any vessel suitable for separating the mixed feed 104 into liquid and vapor fractions. An example is shown in FIG. 2, and described in greater detail below.

The lighter hydrocarbon stream 110 is then passed through a bank of convective heating coils 112 in the heavy feed steam cracker and then fed to a radiant heating section 114 of the heavy feed steam cracker. In the radiant heating section 114 the lighter hydrocarbon stream 113 is thermally cracked to yield a cracked product stream 116. The specific composition of the cracked product stream 116 may, among other factors, depend on the composition of the lighter hydrocarbon stream 113, the ratio of steam to hydrocarbons, and the operating conditions of the steam cracker 114.

The cracked product stream 116 may be fed to a separator where valued light cracked product 122, such as ethylene or propylene, is separated from mid-range 124 to heavier hydrocarbons 118 in separator 120. The heavier hydrocarbons are often referred to as steam cracker tar 118.

Either or both of the bottoms 108 and steam cracker tar 118 may be subjected to hydrodynamic cavitation for viscosity improvement. Although both are subjected to hydrodynamic cavitation in the illustrated embodiment, it should be noted that viscosity reduction may not be desired for one of the product streams in some cases. Furthermore, in some cases, it may be feasible to blend the bottoms 108 and the steam cracker tar 118 before feeding a combined stream to a common hydrodynamic cavitation unit.

In the illustrated embodiment, vapor-liquid separator vessel bottoms 108 are fed to a hydrodynamic cavitation unit 128 by pump 126 under conditions suitable for hydrodynamically cavitating the vapor-liquid separator vessel bottoms and thereby reducing the viscosity of bottoms stream 108. The pressure drop across the cavitation unit 128 may be greater than 400 psig, or greater than 1000 psig, or greater than 2000 psig. The bottoms stream 108 may be supplied to the cavitation unit 128 at a temperature of, for example, 500° F. or more.

Advantageously, high levels of conversion are obtainable from the vapor-liquid separator vessel bottoms 108 as this stream may be highly paraffinic. For such highly paraffinic bottoms streams, cavitation may result in a conversion of about 1 to 50 wt %, or 10 to 50 wt %, 20 to 50 wt %, or 20 to 40 wt % of the 1050+° F. boiling fraction of the bottoms stream 108. The reduced viscosity product stream 140 may then be fed to fractionator 138 or may be sent directly to a disposition such as a fuel oil disposition.

Similarly, steam cracker tar 118 is fed to a hydrodynamic cavitation unit 134 by pump 132 under conditions suitable for hydrodynamically cavitating the steam cracker tar 118 and thereby reducing the viscosity of the steam cracker tar stream 118. The steam cracker tar 118 may have a sulfur content greater than 0.25 wt % or between about 0.25 wt % and 5 wt %. The steam cracker tar 118 may also have a specific gravity between about 1.10 and about 1.50. Although general conditions for hydrodynamic cavitation are descried in greater detail subsequently, pump 132 may supply the tar to the hydrodynamic cavitation unit 134 at a pressure of 400-2500 psig and a temperature of 100-350° C.; preferentially less than 250° C. The pressure drop across the cavitation unit 134 may be greater than 400 psig, or greater than 1000 psig, or greater than 2000 psig. The reduced viscosity product stream 136 may then be fed to the fractionator 138 or may be sent directly to a disposition such as fuel oil. Particularly when separating stream 136, comprising cavitated steam cracker tar product, fractionator 138 may be a low thermal residence separation unit such as a wiped film evaporator or a rotating disk contactor. Furthermore, in the case of cavitated steam cracker tar the temperature of operation for the separator 130 may be less than 350° C., or more preferably less than 250° C. In such a case, the separator may be operated at a pressure and temperature to remove light ends to bring the cavitated steam cracker tar stream 136 into specification for fuel oil flash point. Flash point may be measured by ASTM D6540.

Advantageously, by operating at these pressures and temperatures in the cavitation device 134 and the downstream separator 138, the bulk temperature of the steam cracker tar and cavitated steam cracker tar streams may remain low enough to minimize asphaltene growth and viscosity reversion.

The fractionator 138, with the assistance of a stripping gas such as steam 144, separates the reduced viscosity product streams 130 and 136 into a lighter stream 140 and a heavier stream 146. In any embodiment, at least a portion of the lighter stream 140 may be used as a flux stream 142 and may be recycled upstream of the steam cracker convection section 112, for example mixed with stream 110 downstream of the vapor-liquid separator vessel 106 to pass through the steam cracker convection section 112 and radiant section 114 again. In such an embodiment, the overall olefin yield of the process may be improved.

A fraction 148 taken from near the bottom of fractionator 138 may be used as flux 150 and mixed with the bottoms stream 108 and/or the steam cracker tar stream 118 to improve the performance of the hydrodynamic cavitation units 128, 134 or to improve the yield of lighter hydrocarbons in lighter stream 140. In addition, or in the alternative, a portion of the heavier stream 146 may be used as flux stream 150. The heavier stream 146 may ultimately be blended with other refinery streams to yield fuel oil products 152.

Advantageously the product of the cavitation of steam cracker tar 118 may have a higher solubility number than the stream that is fed to the cavitation device. Furthermore, the product of cavitation may have a kinematic viscosity as measured at 40° C. that is at 25% to 99% lower, or 25% to 95% lower than the stream that is fed to the cavitation device. The cavitated product may also have a density that is at least 0.01 g/cc lower than the stream fed to the cavitation device.

Although FIG. 3 illustrates an integrated system in which both bottoms 108 and steam cracker tar 118 are separately cavitated and then the respective cavitated products 130, 136 are fed to common fractionation unit 138 and overhead and bottoms recycle 142, 150, it should be noted that in any embodiment, the cavitated product streams 130, 136 may be handled by separate separation and/or recycle systems. For example, while it may be desirable to send a light portion of cavitated bottoms product 130 for cracking in the radiant heating section 114 of the steam cracker, however, generally it would not be desirable to send the light fraction of the cavitated steam cracker tar product 136 back to the radiant heating section 114. In addition, in some cases, fractionator 138 may be replaced by a simple vapor-liquid separator, such as a flash unit, to separate volatile components to meet the flash specifications for the products 152, particularly where the products 152 are used for fuel oil disposition. For use of the fuel oil as an on-site fuel, meeting a flash point specification may not be required. Also, some of the overhead products from the fractionator 138 (or separator, as the case may be), may be recycled directly upstream of one or both of the pump 126, 132 feeding the cavitation units for flux.

Furthermore, in some embodiments, only one of bottoms 108 and steam cracker tar 118 is cavitated. Thus, FIG. 3 should be considered a conceptual flow diagram illustrating some of the possible configurations of a system for practicing the present invention and should not limit the scope of the claimed invention.

### Heavy Feed Steam Cracker

FIG. 2 is an exemplary embodiment of a steam cracker system that may be utilized in accordance with the present techniques. In this configuration, a furnace 301, which may be any of a variety of furnaces, includes a convection section 303 and a radiant section 340. The convection section 303 includes various convection section tube banks (e.g., 302, 306, 316, 349 and 323), which may use hot flue gases from the radiant section of the furnace to heat fluids within the respective tube banks.

Along the flow path through the furnace 301, a hydrocarbon feed may have other fluids added, such as steam and/or other hydrocarbons, to the hydrocarbon stream. For instance, the mixing can be accomplished using any mixing device known within the art, such as a first sparger 304 or second sparger 308 of a double sparger assembly 309. In particular, a fluid may pass through a fluid valve 314 and a primary dilution steam may be passed via primary dilution line 317 through a primary dilution steam valve to be mixed with the heated hydrocarbon feed in the respective spargers 304 or 308 to form a mixture stream in lines 311 and 312, which pass through controller 315. Also, a secondary dilution steam stream 318 can be heated in the superheater section 316 of the convection section, may be combined with water via water line 326 through an intermediate desuperheater 325 (e.g., control valve and water atomizer nozzle), and mixed with the heated mixture stream. Optionally, the secondary dilution steam stream 318 may be further split into a flash steam stream in flash steam line 319, which is mixed with the heavy hydrocarbon mixture, and a bypass steam stream in bypass line 321, which is mixed with the vapor phase from the flash before the vapor phase is cracked in the radiant section 340. The flash steam stream may be combined with the mixture stream to form a flash stream in flash line 320.

Along with the addition of certain fluids, certain portions of the hydrocarbon steam may be removed from the process as well. For example, a separator vessel 305 (e.g., flash separator vessel, as exemplified in U.S. Pat. Nos. 7,578,929; 7,488,459; 7,247,765; 7,193,123 and 7,312,371, which are each incorporated herein) may be utilized to separate the flash stream 320 into two phases: a vapor phase comprising predominantly volatile hydrocarbons and steam and a liquid phase comprising predominantly non-volatile hydrocarbons. The vapor phase is preferably removed from the separator vessel 305 as an overhead vapor stream is further processed in a centrifugal separator 338, which removes trace amounts of entrained and/or condensed liquid, before being passed via overhead line 313, vapor phase control valve 336, and crossover line 324 to the radiant section 340 for cracking (e.g., reactor feed). The liquid phase of the flashed mixture stream is removed from a boot or cylinder 335 on the bottom of the separator vessel 305 as a bottoms stream 327 (Kpot bottoms). This stream 327 may be further processed in a pump 337 and cooler 328 with the cooled stream 329 being split into a recycle stream 330 and export stream 322.

Once the stream is exposed to heat in the radiant section 340, the reactor product or effluent may be further processed. For instance, the process may include optional cooling of the effluent from the radiant section 340 in one or more transfer line heat exchangers, a primary fractionator, and a water quench tower or indirect condenser. In this configuration, the effluent (steam cracker tar) may pass via line 341 to a transfer-line exchanger 342 to provide a cooled effluent via quench line 343 for further processing. A utility fluid, such as boiler feed water, may also pass through the transfer-line exchanger 342 to steam drum 347 via lines 344 and 345. The steam drum 347 may be coupled to the third tube bank 349 to generating high pressure steam via lines 348, 52 and 53 and a utility supply line 346. A steam control valve may be coupled between lines 51 and 52 to provide a water source that controls the temperature of the steam.

### Hydrodynamic Cavitation Unit

The term “hydrodynamic cavitation”, as used herein refers to a process whereby fluid undergoes convective acceleration, followed by pressure drop and bubble formation, and then convective deceleration and bubble implosion. The implosion occurs faster than mass in the vapor bubble can transfer to the surrounding liquid, resulting in a near adiabatic collapse. This generates extremely high localized energy densities (temperature, pressure) capable of dealkylation of side chains from large hydrocarbon molecules, cleavage of alkyl linkages between aromatic cores, creating free radicals and other sonochemical reactions.

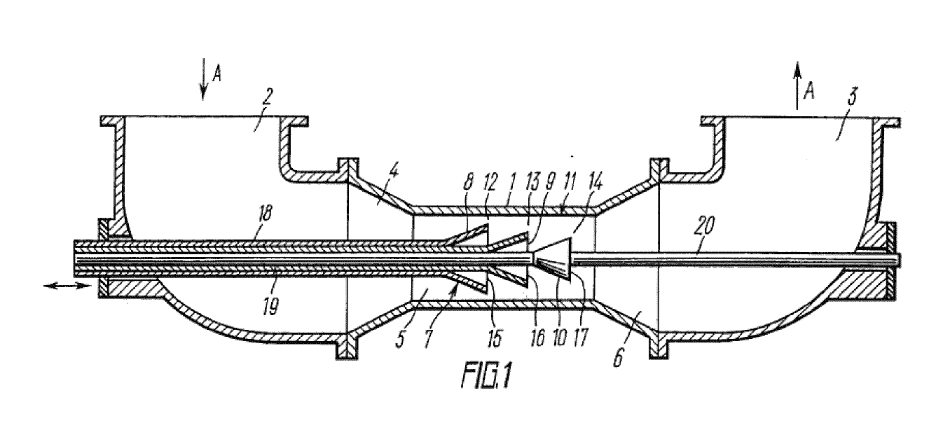

The term “hydrodynamic cavitation unit” refers to one or more processing units that receive a fluid and subject the fluid to hydrodynamic cavitation. In any embodiment, the hydrodynamic cavitation unit may receive a continuous flow of the fluid and subject the flow to continuous cavitation within a cavitation region of the unit. An exemplary hydrodynamic cavitation unit is illustrated in FIG. 1. Referring to FIG. 1, there is a diagrammatically shown view of a device consisting of a housing I having inlet opening 2 and outlet opening 3, and internally accommodating a contractor 4, a flow channel 5 and a diffuser 6 which are arranged in succession on the side of the opening 2 and are connected with one another. A cavitation region defined at least in part by channel 5 accommodates a baffle body 7 comprising three elements in the form of hollow truncated cones 8, 9, 10 arranged in succession in the direction of the flow and their smaller bases are oriented toward the contractor 4. The baffle body 7 and a wall 11 of the flow channel 5 form sections 12, 13, 14 of the local contraction of the flow arranged in succession in the direction of the flow and shaving the cross-section of an annular profile. The cone 8, being the first in the direction of the flow, has the diameter of a larger base 15 which exceeds the diameter of a larger base 16 of the subsequent cone 9. The diameter of the larger base 16 of the cone 9 exceeds the diameter of a larger base 17 of the subsequent cone 10. The taper angle of the cones 8, 9, 10 decreases from each preceding cone to each subsequent cone.

The cones may be made specifically with equal taper angles in an alternative embodiment of the device. The cones 8, 9, 10 are secured respectively on rods 18, 19, 20 coaxially installed in the flow channel 5. The rods 18, 19 are made hollow and are arranged coaxially with each other, and the rod 20 is accommodated in the space of the rod 19 along the axis. The rods 19 and 20 are connected with individual mechanisms (not shown in FIG. 1) for axial movement relative to each other and to the rod 18. In an alternative embodiment of the device, the rod 18 may also be provided with a mechanism for movement along the axis of the flow channel 5. Axial movement of the cones 8, 9, 10 makes it possible to change the geometry of the baffle body 7 and hence to change the profile of the cross-section of the sections 12, 13, 14 and the distance between them throughout the length of the flow channel 5 which in turn makes it possible to regulate the degree of cavitation of the hydrodynamic cavitation fields downstream of each of the cones 8, 9, 10 and the multiplicity of treating the components. For adjusting the cavitation fields, the subsequent cones 9, 10 may be advantageously partly arranged in the space of the preceding cones 8, 9; however, the minimum distance between their smaller bases should be at least equal to 0.3 of the larger diameter of the preceding cones 8, 9, respectively. If required, one of the subsequent cones 9, 10 may be completely arranged in the space of the preceding cone on condition of maintaining two working elements in the baffle body 7. The flow of the fluid under treatment is show by the direction of arrow A.

Hydrodynamic cavitation units of other designs are known and may be employed in the context of the inventive systems and processes disclosed herein. For example, hydrodynamic cavitation units having other geometric profiles are illustrated and described in U.S. Pat. No. 5,492,654, which is incorporated by reference herein in its entirety. Other designs of hydrodynamic cavitation units are described in the published literature, including but not limited to U.S. Pat. Nos. 5,937,906; 5,969,207; 6,502,979; 7,086,777; and 7,357,566, all of which are incorporated by reference herein in their entirety.

In an exemplary embodiment, conversion of hydrocarbon fluid is achieved by establishing a hydrodynamic flow of the hydrodynamic fluid through a flow-through passage having a portion that ensures the local constriction for the hydrodynamic flow, and by establishing a hydrodynamic cavitation field (e.g., within a cavitation region of the cavitation unit) of collapsing vapor bubbles in the hydrodynamic field that facilitates the conversion of at least a part of the hydrocarbon components of the hydrocarbon fluid.

For example, a hydrocarbon fluid may be fed to a flow-through passage at a first velocity, and may be accelerated through a continuous flow-through passage (such as due to constriction or taper of the passage) to a second velocity that may be 3 to 50 times faster than the first velocity. As a result, in this location the static pressure in the flow decreases, for example from 1-20 kPa. This induces the origin of cavitation in the flow to have the appearance of vapor-filled cavities and bubbles. In the flow-through passage, the pressure of the vapor hydrocarbons inside the cavitation bubbles is 1-20 kPa. When the cavitation bubbles are carried away in the flow beyond the boundary of the narrowed flow-through passage, the pressure in the fluid increases.

This increase in the static pressure drives the near instantaneous adiabatic collapsing of the cavitation bubbles. For example, the bubble collapse time duration may be on the magnitude of 10⁻⁶ to 10⁻⁸ second. The precise duration of the collapse is dependent upon the size of the bubbles and the static pressure of the flow. The flow velocities reached during the collapse of the vacuum may be 100-1000 times faster than the first velocity or 6-100 times faster than the second velocity. In this final stage of bubble collapse, the elevated temperatures in the bubbles are realized with a velocity of 10¹⁰-10¹² Ksec. The vaporous/gaseous mixture of hydrocarbons found inside the bubbles may reach temperatures in the range of 1500-15,000K at a pressure of 100-1500 MPa. Under these physical conditions inside of the cavitation bubbles, thermal disintegration of hydrocarbon molecules occurs, such that the pressure and the temperature in the bubbles surpasses the magnitude of the analogous parameters of other cracking processes. In addition to the high temperatures formed in the vapor bubble, a thin liquid film surrounding the bubbles is subjected to high temperatures where additional chemistry (i.e., thermal cracking of hydrocarbons and dealkylation of side chains) occurs. The rapid velocities achieved during the implosion generate a shockwave that can: mechanically disrupt agglomerates (such as asphaltene agglomerates or agglomerated particulates), create emulsions with small mean droplet diameters, and reduce mean particulate size in a slurry.

Advantageously, in any embodiment, a portion of the cavitated product may be recycled upstream of one or both cavitation units to use as flux, mixing with the stream being fed to the cavitation device. This allows for the operation of the cavitation unit at lower operating temperatures than are possible with non-fluxed K-pot bottoms or steam cracker tar. By reducing operating temperature during cavitation asphaltene grown and viscosity reversion may be minimized.

### SPECIFIC EMBODIMENTS

To further illustrate different aspects of the present invention, the following specific embodiments are provided:

Paragraph A—A method for improving viscosity of a heavy hydrocarbon product stream comprising mixing a heavy oil feed with steam to produce a mixed stream; separating the heavy hydrocarbon product stream from the mixed stream; and subjecting the heavy hydrocarbon product stream to hydrodynamic cavitation to crack at least a portion of the hydrocarbons in the heavy hydrocarbon product stream and thereby reduce the viscosity of the heavy hydrocarbon product stream to produce a reduced viscosity product stream.

Paragraph B—The method of Paragraph A, wherein the heavy hydrocarbon product stream is separated from the mixed stream after the mixed stream is fed to a heavy feed steam cracker.

Paragraph C—The method of Paragraph A, wherein the heavy hydrocarbon product stream is separated from the mixed stream upstream of a heavy feed steam cracker radiant cracking section.

Paragraph C—The method of Paragraph A or B, wherein the heavy hydrocarbon product stream comprises steam cracker tar.

Paragraph D—The method of Paragraph A or C, wherein the heavy hydrocarbon product stream is a bottoms product of a vapor-liquid separator vessel, and wherein the vapor-liquid separator vessel separates the heavy hydrocarbon product stream from a lighter hydrocarbon stream, and wherein the lighter hydrocarbon steam is fed with the steam to a steam cracker.

Paragraph E—The method of any of Paragraphs A-D, further comprising blending a fuel oil comprising the reduced viscosity product stream.

Paragraph F—The method of any of Paragraphs A-E, further comprising fractionating the reduced viscosity product stream into a light stream and a heavy stream.

Paragraph G—The method of Paragraph F, further comprising feeding the light stream to a stream cracker.

Paragraph H—A system for improving viscosity of a heavy hydrocarbon product stream comprising: a vapor-liquid separator drum configured to receive a mixed feed of heavy oil and steam and configured to separate the mixed feed into a steam cracker feed stream comprising steam and lighter hydrocarbons in the mixed feed and a bottoms stream; a steam cracker downstream of the vapor-liquid separator drum and configured to receive the steam cracker feed stream, wherein the steam cracker is adapted to crack the steam cracker feed to yield a cracked hydrocarbon stream and a steam cracker tar stream; and a hydrodynamic cavitation unit configured to receive a product stream selected from the group consisting of the bottoms stream, the steam cracker tar stream, or a combination thereof, wherein the hydrodynamic cavitation unit is adapted to hydrodynamically cavitate the product stream to reduce the viscosity of the product stream.

Paragraph I—A system for improving viscosity of a heavy hydrocarbon product stream comprising: a vapor-liquid separator drum configured to receive a mixed feed of a heavy hydrocarbon feed having a T50 greater than or equal to 400° F. and a T95 greater than or equal to 650° F. and steam and configured to separate the mixed feed into (a) a steam cracker feed stream comprising steam and lighter hydrocarbons in the mixed feed and (b) a bottoms stream; a steam cracker downstream of the vapor-liquid separator drum and configured to receive the steam cracker feed stream, wherein the steam cracker is adapted to crack the steam cracker feed stream to yield a cracked hydrocarbon stream and a steam cracker tar stream; and a hydrodynamic cavitation unit configured to receive a product stream selected from the group consisting of the bottoms stream, the steam cracker tar stream, or a combination thereof, wherein the hydrodynamic cavitation unit is adapted to hydrodynamically cavitate the product stream and thereby reduce the viscosity of the product stream.

Paragraph J—A system for improving viscosity of a heavy hydrocarbon product stream comprising: a vapor-liquid separator drum configured to receive a mixed feed of a heavy hydrocarbon feed having a T50 greater than or equal to 400° F. and a T95 greater than or equal to 650° F. and steam and configured to separate the mixed feed into (a) a steam cracker feed stream comprising steam and lighter hydrocarbons in the mixed feed and (b) a bottoms stream; a steam cracker downstream of the vapor-liquid separator drum and configured to receive the steam cracker feed stream, wherein the steam cracker is adapted to crack the steam cracker feed to yield a plurality of cracked hydrocarbon streams; and a cavitation device configured to receive the bottoms stream and reduce the viscosity of the bottoms stream.

Paragraph K—The system of Paragraph J, wherein the cavitation device is a hydrodynamic cavitation device adapted to hydrodynamically cavitate the bottoms stream.

Paragraph L—A method for treating a heavy steam cracker vapor-liquid separator drum bottoms stream comprising: subjecting a bottoms stream from a heavy steam cracker vapor-liquid separator drum to hydrodynamic cavitation in a cavitation device to convert at least a portion of the hydrocarbons present in the bottoms stream to lower molecular weight hydrocarbons and thereby yield a converted product stream having a viscosity less than the bottoms stream.

Paragraph M—The method of Paragraph L, wherein the bottoms stream comprises a 1050° F. boiling fraction, and about 1 to about 50 wt % of the 1050+° F. boiling fraction is converted when subjected to hydrodynamic cavitation.

Paragraph N—The method of Paragraphs L or M, wherein the bottoms stream is subjected to a pressure drop greater than 400 psig, or more preferably greater than 1000 psig, or even more preferably greater than 1000 psig when subjected to hydrodynamic cavitation.

Paragraph O—The method of any of Paragraphs L-N, wherein the bottoms stream is fed to a cavitation unit at a temperature of 500° F., or more.

Paragraph P—The method of any of Paragraphs L-O, wherein a portion of the converted lower molecular weight hydrocarbons are recycled to the cavitation device.

Paragraph Q—The method of any of Paragraphs L-P, wherein a portion of the converted lower molecular weight hydrocarbons are recycled to the vapor-liquid separator drum.

Paragraph R—The method of Paragraphs L-Q, further comprising separating a lower boiling point fraction and a higher boiling point fraction from the converted product stream.

Paragraph S—The method of Paragraph R, further comprising feeding at least a portion of the lower boiling point fraction to a steam cracker.

Paragraph T—The method or system of any of Paragraphs A-S, wherein the hydrodynamic cavitation is performed in the absence of a catalyst.

Paragraph U—The method or system of any of Paragraphs A-T, wherein the hydrodynamic cavitation is performed in the absence of a hydrogen gas or wherein hydrogen gas is present in the bottoms stream at less than 50 standard cubic feet per barrel.

Paragraph V—The method or system of any of Paragraphs A-U, wherein the hydrodynamic cavitation is performed in the absence of a diluent oil or free water.

Paragraph W—The method of any of Paragraphs L-U, further comprising separating the cavitated product stream to a vapor stream and an oil stream having a flash point of greater than 60° C.

Paragraph X—The method of Paragraph W, further comprising scrubbing the vapor stream with an amine solution.

Paragraph Y—The method of any of Paragraphs L-X, further comprising obtaining from the converted product stream an oil having a viscosity of less than or equal to about 380 cSt at 50° C., and/or a specific gravity of between about 0.96 and about 1.01, and/or a maximum sulfur level of 3.5 wt % or less or 1.5 wt % or less.

Paragraph Z—The method of any of Paragraphs L-Y, wherein at least a portion of the cavitated product stream is further upgraded by distillation, hydroprocessing, hydrocracking, fluidized catalytic cracking, dewaxing, delayed coking, fluid coking, partial oxidation, gasification, deasphalting, or a combination thereof.

Paragraph AA—A system for treating a heavy hydrocarbon product stream comprising: a mixed feed stream comprising a heavy hydrocarbon feed having a T50 greater than or equal to 400° F. and a T95 greater than or equal to 650° F. and steam; a steam cracker that is adapted to crack the mixed feed to yield a plurality of cracked hydrocarbon products; a separator that separates the plurality of cracked hydrocarbon products into at least two fractions including a bottoms product fraction; and a cavitation device configured to receive a bottoms product fraction from the separation vessel.

Paragraph BB—The system of Paragraph AA, wherein the cavitation device is a hydrodynamic cavitation device.

Paragraph CC—A method of treating a heavy hydrocarbon containing stream comprising: subjecting a bottoms product stream from a steam cracker to hydrodynamic cavitation with a cavitation device to convert at least a portion of the hydrocarbons present in the bottoms product stream to lower molecular weight hydrocarbons and thereby yield a converted product stream having a viscosity less than the bottoms product stream.

Paragraph EE—The method of Paragraph CC, wherein the bottoms product stream contains greater than 0.25 wt % S.

Paragraph FF—The method of any of Paragraphs CC-EE, wherein about 1 to about 50 wt % of a 750+° F. boiling fraction of the bottoms product stream is converted when subjected to hydrodynamic cavitation.

Paragraph GG—The method of any of Paragraphs CC-FF, wherein the bottoms product stream is subjected to a pressure drop greater than 400 psig, or more preferably greater than 1000 psig, or even more preferably greater than 2000 psig when subjected to hydrodynamic cavitation.

Paragraph HH—The method of any of Paragraphs CC-GG, wherein the bottoms stream is fed to a cavitation unit at a temperature of about 100 to about 250° C.

Paragraph II—The method of any of Paragraphs CC-HH, wherein a portion of the converted lower molecular weight hydrocarbons are recycled to the cavitation device.

Paragraph JJ—The method of any of Paragraphs CC-II, wherein a portion of the converted lower molecular weight hydrocarbons are fed to a separator.

Paragraph KK—The method of any of Paragraphs CC-JJ, further comprising separating a lower boiling point fraction from a higher boiling point fraction from the converted product stream.

Paragraph LL—The method of Paragraph KK, further comprising feeding at least a portion of the lower boiling point fraction to a steam cracker.

Paragraph MM—The system or method of any of Paragraphs AA-LL, wherein the hydrodynamic cavitation is performed in the absence of a catalyst.

Paragraph NN—The system or method of any of claims AA-MM, wherein the hydrodynamic cavitation is performed in the absence of a hydrogen gas or wherein hydrogen gas is present in the bottoms product stream at less than 50 standard cubic feet per barrel.

Paragraph OO—The system or method of any of claims AA-NN, wherein the hydrodynamic cavitation is performed in the absence of a diluent oil or free water.

Paragraph PP—The method of any of Paragraphs CC-OO, further comprising obtaining from the converted product stream an oil having a viscosity of less than or equal to about 380 cSt at 50° C.

Paragraph QQ—The method of any of Paragraphs CC-PP, further comprising obtaining from the converted product stream an oil having a specific gravity of between about 0.96 and 1.01.

Paragraph RR—The method of any of Paragraphs CC-QQ, further comprising blending at least a portion of the converted product stream with a cutter stock to achieve a maximum sulfur level of 3.5 wt %.

Paragraph SS—The method of any of Paragraphs CC-RR, wherein at least a portion of the cavitated product stream is further upgraded by distillation, hydroprocessing, hydrocracking, fluidized catalytic cracking, dewaxing, delayed coking, fluid coking, partial oxidation, gasification, deasphalting, or a combination thereof.

Paragraph TT—The method of any of Paragraphs CC-SS, wherein the bottoms product stream comprises steam cracker tar.

Paragraph UU—A product obtained by the method or from the system of any of Paragraphs A-TT.

Paragraph VV—The product of Paragraph UU, wherein the product has a higher solubility number than the heavy hydrocarbon containing stream that is fed to the cavitation device. The increase in the solubility number may be by 5 point, 10, points, 15 points, or more.

Paragraph WW—The product of any of Paragraphs UU-VV, wherein the product has a kinematic viscosity as measured at 40° C. is at 25% to 99% lower than the heavy hydrocarbon containing stream that is fed to the cavitation device.

Paragraph XX—The product of any of Paragraphs UU-WW, wherein the product has a density that is at least 0.01 g/cc lower than the heavy hydrocarbon containing stream fed to the cavitation device.

Paragraph YY—The product of any of Paragraphs UU-XX, having a viscosity of less than or equal to 380 cSt at 50° C., a specific gravity of between about 0.96 and about 1.01, or a sulfur level of 3.5 wt % or less.

### Example One

Steam cracker tar obtained from the steam cracking of a Low Sulfur Waxy Resid was subjected to hydrodynamic cavitation. The neat tar had a density of 1.0615 g/mL, a viscosity at 40° C. of 9186 cSt, and a viscosity at 100° C. of 82 cSt. The cavitated tar had a density of 1.0520, a viscosity at 40° C. of 539 cSt, and a viscosity at 100° C. of 17 cSt. The level of viscosity reduction seen was surprising both because of the magnitude of the reduction and because the tar lacks the high asphaltene content of the resid. That tar is hydrogen poor and the small branches (compared to asphaltenes) made the magnitude of the viscosity reduction even more surprising.

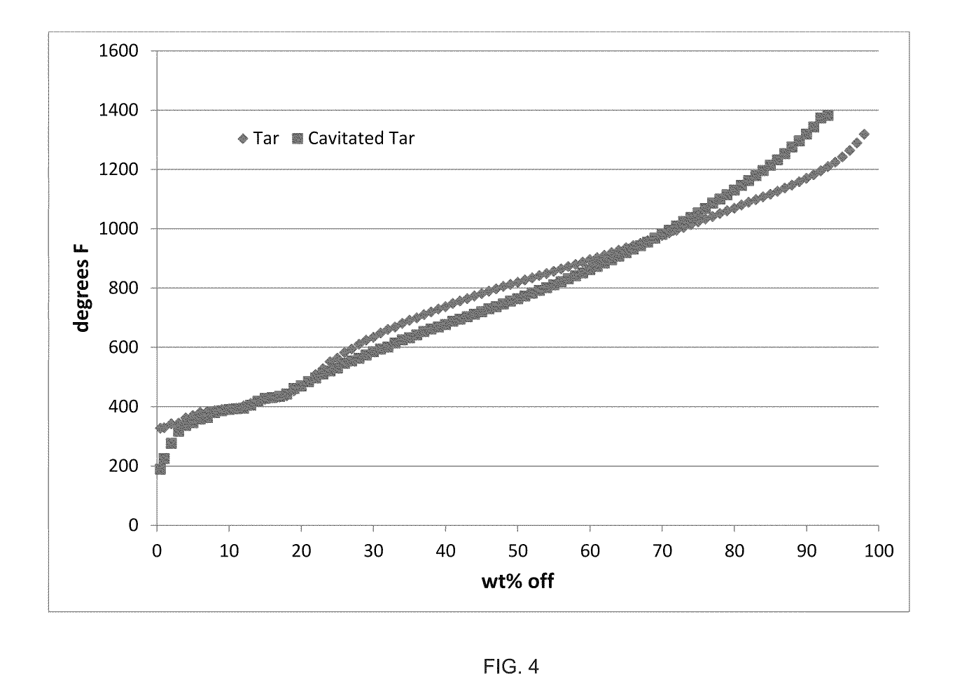

FIG. 4 shows the simulated distillation boiling point curves for neat and cavitated steam cracker tar.

The steam cracker tar had a solubility number of 161 and an insolubility number of 104. The cavitated steam cracker tar had a solubility number of 188 and an insolubility number of 139. Solubility number and insolubility number are defined, along with methods of calculation, by Wiehe, I. and R. Kennedy, Energy & Fuels, 2000, 14, 56-59.

Without being bound by theory, it is believed that cleavage of vinyl linkages between aromatic cores is the source of the viscosity reduction. It is believed that the moderate bulk temperatures, particularly in the range of 150-300° C. allows for the “depolymerization” of the tar but the short duration the cavitation events and low bulk temperature of the cavitation process does not provide adequate conditions for recombination.

What is claimed is:

1. A system for improving viscosity of a heavy hydrocarbon product stream comprising:
a vapor-liquid separator drum configured to receive a mixed feed of a heavy hydrocarbon feed having a T50 greater than or equal to 400° F. and a T95 greater than or equal to 650° F. and steam and configured to separate the mixed feed into (a) a steam cracker feed stream comprising steam and volatile hydrocarbons in the mixed feed and (b) a bottoms stream;
a steam cracker receiving the steam cracker feed stream, wherein the steam cracker is adapted to crack the steam cracker feed stream to yield a cracked hydrocarbon stream including a stream cracker tar stream; and
a hydrodynamic cavitation unit configured to receive a product stream selected from the group consisting of the bottoms stream, the steam cracker tar stream, or a combination thereof, wherein the hydrodynamic cavitation unit is adapted to hydrodynamically cavitate the product stream and thereby reduce the viscosity of the product stream.

2. A system for improving viscosity of a heavy hydrocarbon product stream comprising:
a vapor-liquid separator drum configured to receive a mixed feed of a heavy hydrocarbon feed having a T50 greater than or equal to 400° F. and a T95 greater than or equal to 650° F. and steam and configured to separate the mixed feed into (a) a steam cracker feed stream comprising steam and volatile hydrocarbons in the mixed feed and (b) a bottoms stream;
a steam cracker receiving the steam cracker feed stream, wherein the steam cracker is adapted to crack the steam cracker feed to yield a plurality of cracked hydrocarbon streams; and
a cavitation device configured to receive the bottoms stream and reduce the viscosity of the bottoms stream.

3. The system of claim 2, wherein the cavitation device is a hydrodynamic cavitation device adapted to hydrodynamically cavitate the bottoms stream.

4. A method for treating a heavy steam cracker vapor-liquid separator drum bottoms stream comprising:
subjecting a bottoms stream from a heavy steam cracker vapor-liquid separator drum to hydrodynamic cavitation in a cavitation device to convert at least a portion of the hydrocarbons present in the bottoms stream to lower molecular weight hydrocarbons and thereby yield a converted product stream having a viscosity less than the bottoms stream.

5. The method of claim 4, wherein the bottoms stream comprises a 1050+° F. boiling fraction, and about 1 to about 50 wt % of the 1050+° F. boiling fraction is converted when subjected to hydrodynamic cavitation.

6. The method of claim 4, wherein the bottoms stream is subjected to a pressure drop greater than 400 psig when subjected to hydrodynamic cavitation.

7. The method of claim 6, wherein the pressure drop is greater than 1000 psig.

8. The method of claim 7, wherein the pressure drop is greater than 2000 psig.

9. The method of claim 4, wherein the bottoms stream is fed to a cavitation unit at a temperature of 500° F. or more.

10. The method of claim 4, wherein a portion of the converted lower molecular weight hydrocarbons are recycled to the cavitation device.

11. The method of claim 4, wherein a portion of the converted lower molecular weight hydrocarbons are recycled to the vapor-liquid separator drum.

12. The method of claim 4, further comprising separating a lower boiling point fraction from a higher boiling point fraction from the converted product stream.

13. The method of claim 12, further comprising feeding at least a portion of the lower boiling point fraction to a steam cracker.

14. The method of claim 4, wherein the hydrodynamic cavitation is performed in the absence of a catalyst.

15. The method of claim 4, wherein the hydrodynamic cavitation is performed in the absence of a hydrogen containing gas or wherein hydrogen gas is present in the bottoms stream at less than 50 standard cubic feet per barrel.

16. The method of claim 4, wherein the hydrodynamic cavitation is performed in the absence of a diluent oil or free water.

17. The method of claim 4, further comprising separating the cavitated product stream to a vapor stream and an oil stream having a flash point of greater than 60° C.

18. The method of claim 17, further comprising scrubbing the vapor stream with an amine solution.

19. The method of claim 4, further comprising obtaining from the converted product stream an oil having a viscosity of less than or equal to about 380 cSt at 50° C.

20. The method of claim 4, further comprising obtaining from the converted product stream an oil having a specific gravity of between about 0.96 and about 1.01 as measured at 15° C.

21. The method of claim 4, further comprising blending at least a portion of the converted product stream with a cutter stock to achieve a maximum sulfur level of 3.5 wt % or less.

22. The method of claim 4, wherein at least a portion of the cavitated product stream is further upgraded by distillation, hydroprocessing, hydrocracking, fluidized catalytic cracking, dewaxing, delayed coking, fluid coking, partial oxidation, gasification, deasphalting, or a combination thereof.

23. A system for treating a heavy hydrocarbon product stream comprising:
a mixed feed stream comprising a heavy hydrocarbon feed having a T50 greater than or equal to 400° F. and a T95 greater than or equal to 650° F. and steam;
a steam cracker that is adapted to crack the mixed feed to yield a plurality of cracked hydrocarbon products;
a separator that separates the plurality of cracked hydrocarbon products into at least two fractions including a bottoms product fraction; and
a cavitation device configured to receive a bottoms product fraction from the separation vessel.

24. The system of claim 23, wherein the cavitation device is a hydrodynamic cavitation device.

25. A method of treating a heavy hydrocarbon containing stream comprising:
subjecting a bottoms product stream from a steam cracker to hydrodynamic cavitation with a cavitation device to convert at least a portion of the hydrocarbons present in the bottoms product stream to lower molecular weight hydrocarbons and thereby yield a converted product stream having a viscosity less than the bottoms product stream.

26. The method of claim 25, wherein the bottoms product stream contains greater than 0.25 wt % S.

27. The method of claim 25, wherein the bottoms product stream is subjected to a pressure drop greater than 400 psig when subjected to hydrodynamic cavitation.

28. The method of claim 27, wherein the pressure drop is greater than 1000 psig.

29. The method of claim 28, wherein the pressure drop is greater than 2000 psig.

30. The method of claim 25, wherein the bottoms product stream is fed to a cavitation unit at a temperature of about 100 to about 250° C.

31. The method of claim 25, wherein a portion of the converted lower molecular weight hydrocarbons are recycled to the cavitation device.

32. The method of claim 25, wherein a portion of the converted lower molecular weight hydrocarbons are fed to a separator.

33. The method of claim 25, further comprising separating a lower boiling point fraction from a higher boiling point fraction from the converted product stream.

34. The method of claim 33, further comprising feeding at least a portion of the lower boiling point fraction to a steam cracker.

35. The method of claim 25, wherein the hydrodynamic cavitation is performed in the absence of a catalyst.

36. The method of claim 25, wherein the hydrodynamic cavitation is performed in the absence of a hydrogen containing gas or wherein hydrogen gas is present in the bottoms product stream at less than 50 standard cubic feet per barrel.

37. The method of claim 25, wherein the hydrodynamic cavitation is performed in the absence of a diluent oil or free water.

38. The method of claim 25, further comprising obtaining from the converted product stream an oil having a viscosity of less than or equal to about 380 cSt at 50° C.

39. The method of claim 25, further comprising obtaining from the converted product stream an oil having a specific gravity of between about 0.96 and about 1.10.

40. The method of claim 25, further comprising blending at least a portion of the converted product stream with a cutter stock to achieve a maximum sulfur level of 3.5 wt %.

41. The method of claim 25, wherein at least a portion of the cavitated product stream is further upgraded by distillation, hydroprocessing, hydrocracking, fluidized catalytic cracking, dewaxing, delayed coking, fluid coking, partial oxidation, gasification, deasphalting, or a combination thereof.

42. The method of claim 25, wherein the bottoms product stream comprises steam cracker tar.

43. A product obtained by the method of claim 25.

44. The product of claim 43, wherein the product has a higher solubility number than the heavy hydrocarbon containing stream that is fed to the cavitation device.

45. The product of claim 43, wherein the product has a kinematic viscosity as measured at 40° C. is at 25% to 99% lower than the heavy hydrocarbon containing stream that is fed to the cavitation device.

46. The product of claim 43, wherein the product has a density that is at least 0.01 g/cc lower than the heavy hydrocarbon containing stream fed to the cavitation device.

47. The product of claim 43, having a viscosity of less than or equal to 380 cSt at 50° C., a specific gravity of between about 0.96 and about 1.10, or a sulfur level of 3.5 wt % or less.
